(19) United States
(12) Patent Application Publication
(10) Pub. No.: US 2016/0221494 A1
(43) Pub. Date: Aug. 4, 2016

(54) CONTROL SYSTEM AND CONTROL METHOD FOR COLLISION AVOIDANCE WHILE OPENING VEHICLE DOOR

(71) Applicant: HON HAI PRECISION INDUSTRY CO., LTD., New Taipei (TW)

(72) Inventors: MENG-YU CHUNG, New Taipei (TW); YI-CHUAN LIAO, New Taipei (TW)

(21) Appl. No.: 14/736,987

(22) Filed: Jun. 11, 2015

(30) Foreign Application Priority Data
Feb. 4, 2015 (TW) 104103686

(51) Int. Cl. B60Q 1/32; B60R 11/04; B60R 1/00; B60Q 1/00; B60Q 5/00

(52) U.S. Cl. CPC B60Q 1/323; B60Q 1/0023; B60Q 5/005; B60R 1/00; B60R 11/04; B60R 2300/202; B60R 2300/802

(57) ABSTRACT

A control system for collision avoidance while opening vehicle door is provided. The control system is running on a vehicle. The control system includes a light control module and a sound control module. The light control module is used to control a light prompting unit to flicker when a speed sensing unit senses that a moving speed of the vehicle is zero. The sound control module is used to control a sound prompting unit to alarm when the moving speed of the vehicle is zero and a heat sensing unit of the vehicle senses that a heat source is moving close to an inner handle of the vehicle. A control method for collision avoidance while opening vehicle door is also provided.

### FIELD

The subject matter herein generally relates to control systems and control methods for collision avoidance while opening vehicle door.

### BACKGROUND

No matter a driver or passengers on a vehicle, may both have an accident because they don't pay attention to rear cars or pedestrians while opening a vehicle door of the vehicle. At present, although there are many such accident prevention mechanisms for avoiding such accident, they may still cause misjudgment, for example, it has issued a prompting while the driver or the passengers are not going to get off, or it has issued no prompting when the driver or the passengers have opened the vehicle door.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of a control system for collision avoidance while opening vehicle door.

FIG. 2 is a block diagram of an embodiment of a vehicle.

FIG. 3 is a diagrammatic view of an embodiment of a vehicle door.

FIG. 4 is a diagrammatic view of an embodiment of an inside of a vehicle.

FIGS. 5 and 6 cooperatively constitute a signal flowchart of an embodiment of a control method for collision avoidance while opening vehicle door.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

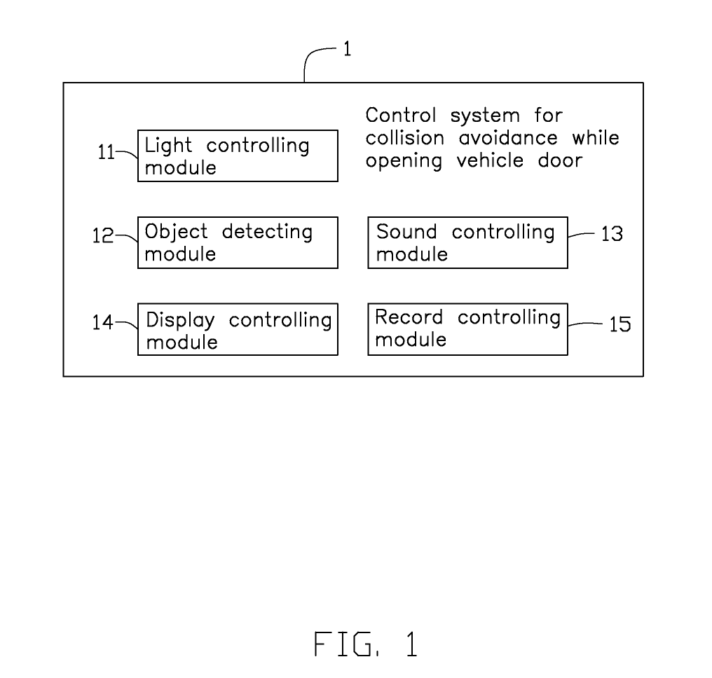

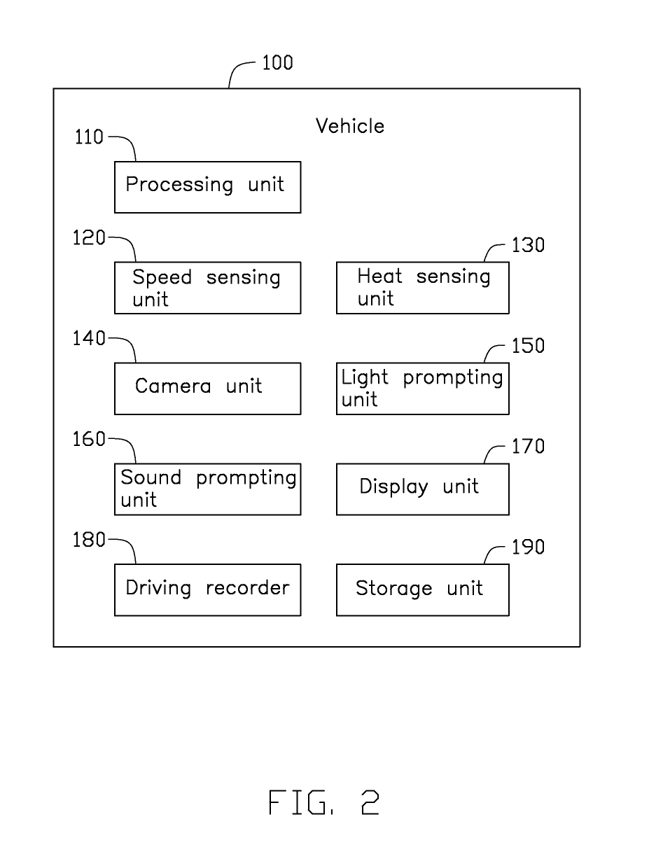

FIG. 1 shows a control system for collision avoidance while opening vehicle door 1. The control system 1 can be run on but not limited to a vehicle 100 which is shown on FIG. 2.

Referring to FIG. 2, the vehicle 100 can include a processing unit 110, a speed sensing unit 120, a number of heat sensing unit 130, a camera unit 140, a light prompting unit 150, a sound prompting unit 160, a display unit 170, a driving recorder 180 and a storage unit 190. The speed sensing unit 120, the number of heat sensing unit 130, the camera unit 140, the light prompting unit 150, the sound prompting unit 160, the display unit 170, the driving recorder 180 and the storage unit 190 can be electrically coupled to the processing unit 110 respectively.

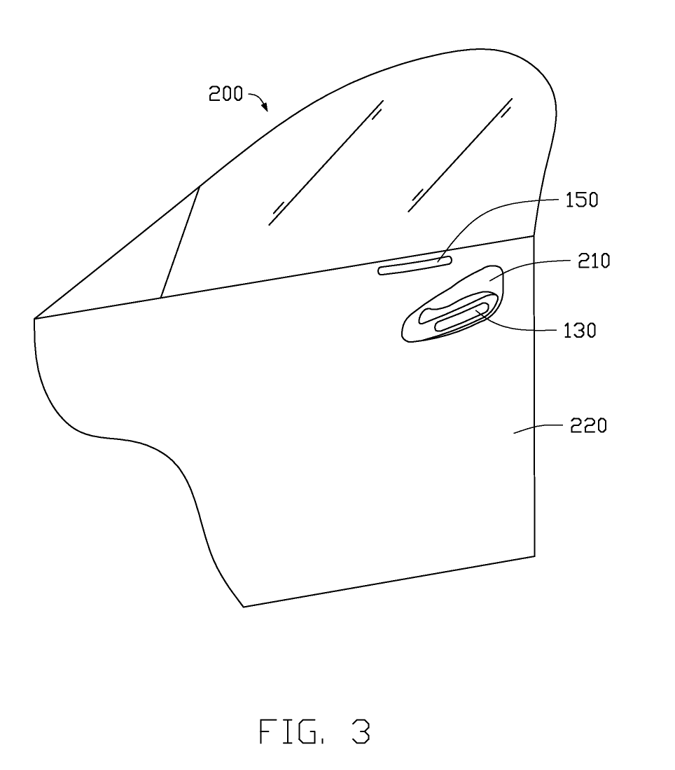

Referring to FIG. 3, the vehicle 100 can further include a number of vehicle doors 200, such as left front vehicle door, left hand rear door, right front vehicle door, or right rear vehicle door, or the like. Each vehicle door 200 can include an inner handle 210 and an inner panel 220. The vehicle 100 can further include two outside rearview mirrors (not shown). Each outside rearview mirror can be located on one side of a vehicle body (not shown) of the vehicle 100.

Referring to FIGS. 2 and 3, the processing unit 110 can be used to control the speed sensing unit 120, the number of heat sensing units 130, the camera unit 140, the light prompting unit 150, the sound prompting unit 160, the display unit 170, the driving recorder 180 and the storage unit 190 to cooperatively work.

The speed sensing unit 120 can be used to sense a moving speed of the vehicle 100 in real time, and further transmit the sensed moving speed to the processing unit 110.

The heat sensing unit 130 can include a number of heat-sensitive sensors. Each inner handle 210 can attach at least one heat-sensitive sensor thereon. The at least one heat-sensitive sensor can be used to sense a coming heat source.

The camera unit 140 can include at least two cameras. Each outside rearview mirror can attach at least one camera. The at least one camera can be used to film environment images beside the vehicle body of the vehicle 100. In this embodiment, each outside rearview mirror can attach only one camera.

The light prompting unit 150 can include a number of light guiding plates. Each inner panel 220 can attach at least one light guide plate. The light prompting unit 150 can be used to flicker with a certain frequency to prompt the driver and/or the passengers on the vehicle 100. In this embodiment, each inner panel 220 can attach only one light guide plate, although the invention is not so limited and more than one may be used.

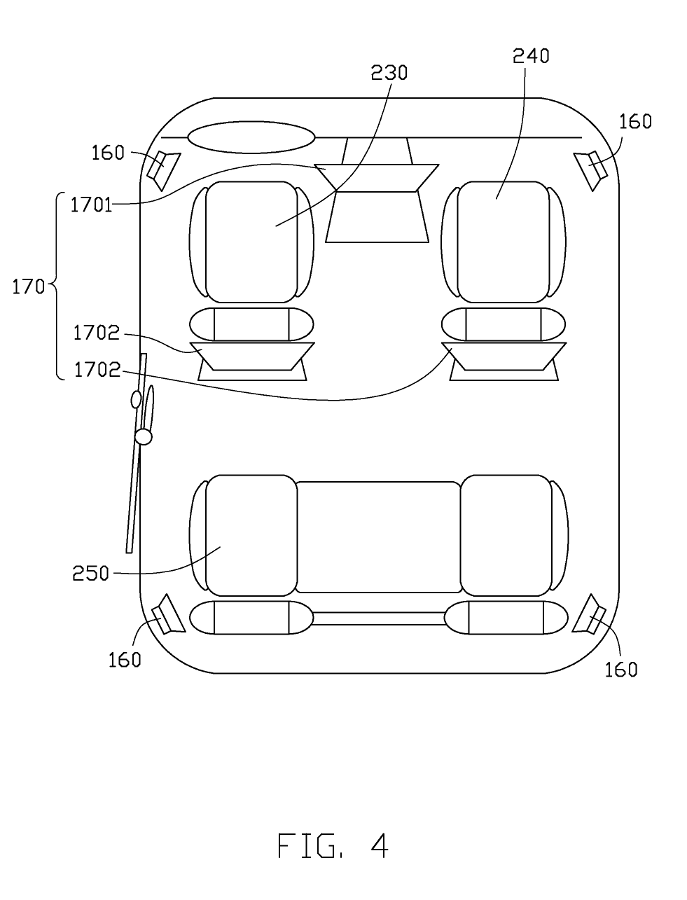

Referring to FIG. 4, the sound prompting unit 160 can include a number of loudspeakers. The vehicle 100 can further include a driver's seat 230, a passenger's seat 240 and a back seat 250. Each loudspeaker can locate close to the driver's seat 230, the passenger's seat 240 or the back seat 250 and further located close to one inner panel 220. The number of loudspeakers can be used to alarm with a certain frequency to prompt the driver and/or the passengers on the vehicle. In this embodiment, each location which is close to one inner panel 220 can attach only one loudspeaker.

The display unit 170 can include a first display unit 1701 mounted on a front side of the driver's seat 230 of the vehicle 100 and two second display unit 1702 mounted on a back side of the driver's seat 230 of the vehicle 100 and a back side of the passenger's seat 240 of the vehicle 100 respectively. The display unit 170 can be used to display environment images filmed by the camera unit 140 in real time.

The driving recorder 180 can be mounted on a front side and/or a back side of the vehicle 100, and used to film environment images beside the front side and/or the back side of the vehicle 100.

In at least one embodiment, the processing unit 110 can be a central processing unit, a digital signal processor, or a single chip, for example.

In at least one embodiment, the storage unit 190 can be an internal storage system, such as a flash memory, a random access memory (RAM) for temporary storage of information, and/or a read-memory (ROM) for permanent storage of information.

In at least one embodiment, the storage unit 190 can also be a storage system, such as a hard disk, a storage card, or a data storage medium. The storage unit 190 can include volatile and/or non-volatile storage devices.

In at least one embodiment, the storage unit 190 can include two or more storage devices such that one storage device is a memory and the other storage device is a hard drive. Additionally, the storage unit 190 can be respectively located either entirely or partially external relative to the vehicle 100.

Referring to FIG. 1 again, the control system 1 can include a number of modules, and the number of modules can include a light controlling module 11, an object detecting module 12, a sound controlling module 13, a display controlling module 14 and a record controlling module 15. The number of modules can be stored in the storage unit 190, and further applied on the processing unit 110. The modules of the control system 1 can include separated functionalities represented by hardware or integrated circuits, or as software and hardware combinations, such as a special-purpose processor or a general-purpose processor with special-purpose firmware. The details are as follows.

The light controlling module 11 can be used to control the light prompting unit 150 to flicker with a certain frequency to prompt the driver and/or the passengers on the vehicle 100 when the sensed moving speed is zero, that is, the vehicle 100 is not moving.

The object detecting module 12 can be used to control the camera unit 140 to film environment images of a side of the vehicle 100 when the sensed moving speed is zero, and further determine whether a size of a certain feature of an object in the continuous environment images is becoming larger, and determine that there is an object moving close to the vehicle 100 when determined that a size of a certain feature of an object in the continuous environment images is becoming larger.

The light controlling module 11 can be used to control the light prompting unit 150 to flicker with an increased frequency to prompt the driver and/or the passengers on the vehicle 100 when determined that there is an object moving close to the side of the vehicle 100, and the less distance between the moving object and vehicle 100, and the larger frequency applied by the light prompting unit 150 flicker.

When the sensed moving speed is zero and the heat sensing unit 130 senses that there is a heat source moving close to an inner handle 210, the sound controlling module 13 can be used to control the sound prompting unit 160 which is close to the inner handle 210 to alarm with a certain frequency to prompt the driver and/or the passengers on the vehicle 100.

The sound controlling module 13 can be further used to control the sound prompting unit 160 which is close to the inner handle 210 to alarm with an increased frequency to prompt the driver and/or the passengers on the vehicle 100 when determined that there is an object moving close to the vehicle 100, and the less distance between the moving object and vehicle 100, and the larger frequency of the sound prompting unit 150 alarms.

When the sensed moving speed is zero and the heat sensing unit 130 senses that there is a heat source moving close to an inner handle 210, the display controlling module 14 can be used to control the display unit 170 close to the inner handle 210 to display the environment images filmed by the camera unit 140. In this embodiment, when the sensed moving speed is zero and the heat sensing unit 130 senses that there is a heat source moving close to an inner handle 210, the display controlling module 14 can be used to control the first display unit 1701 or the second display unit 1702 which is close to the inner handle 210 to display the environment images filmed by the camera unit 140.

The record controlling module 15 can be used to control the driving recorder 180 to record environment images when the sensed moving speed is zero and the heat sensing unit 130 senses that there is a heat source moving close to an inner handle 210, and further control the storage unit 190 to store the recorded environment images. Heat sensing unit 130 is a non-limiting example of an activity sensor in the vehicle that senses movement proximate to the handle 210, but the invention is not limited to a heat sensor. For example, a motion sensor, or a light sensor that detects changes in light (e.g., such as when a handle is covered by a hand), could also be used.

In at least one embodiment, the object detecting module 12 can be omitted, and the light prompting unit 150 and the sound prompting unit 160 can be used to prompt with a certain frequency. Other alarm patterns, such as simple ON/OFF could be used rather than frequency control.

In at least one embodiment, the display unit 170 can be omitted, and the display controlling module 14 and the camera unit 140 can be thus omitted.

In at least one embodiment, the driving recorder 180 can be omitted, and the record controlling module 15 can be thus omitted.

In at least one embodiment, the light prompting unit 150 flickers can be a first alarm, and the sound prompting unit 160 alarms can be a second alarm.

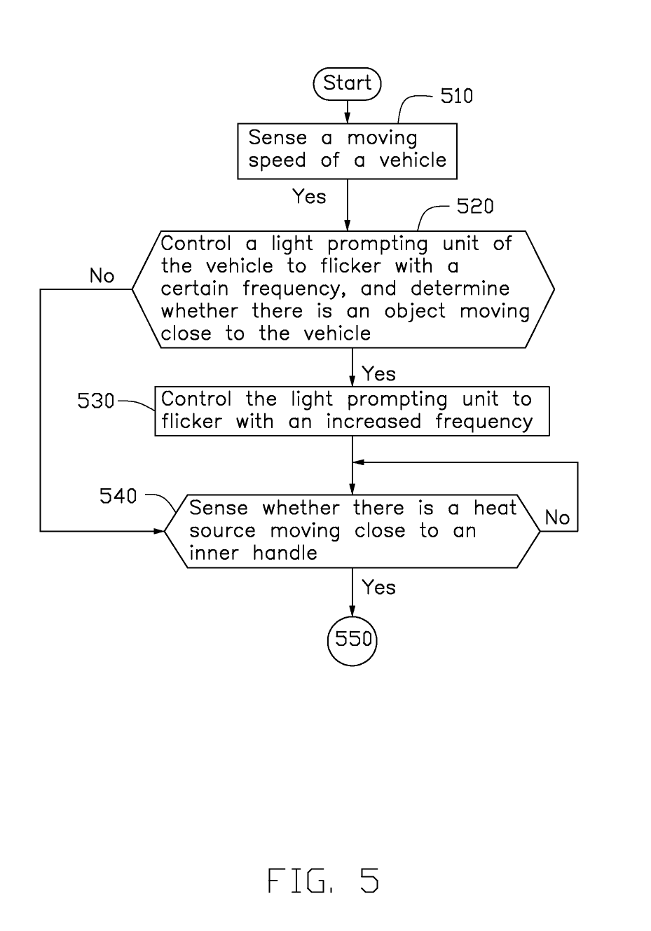

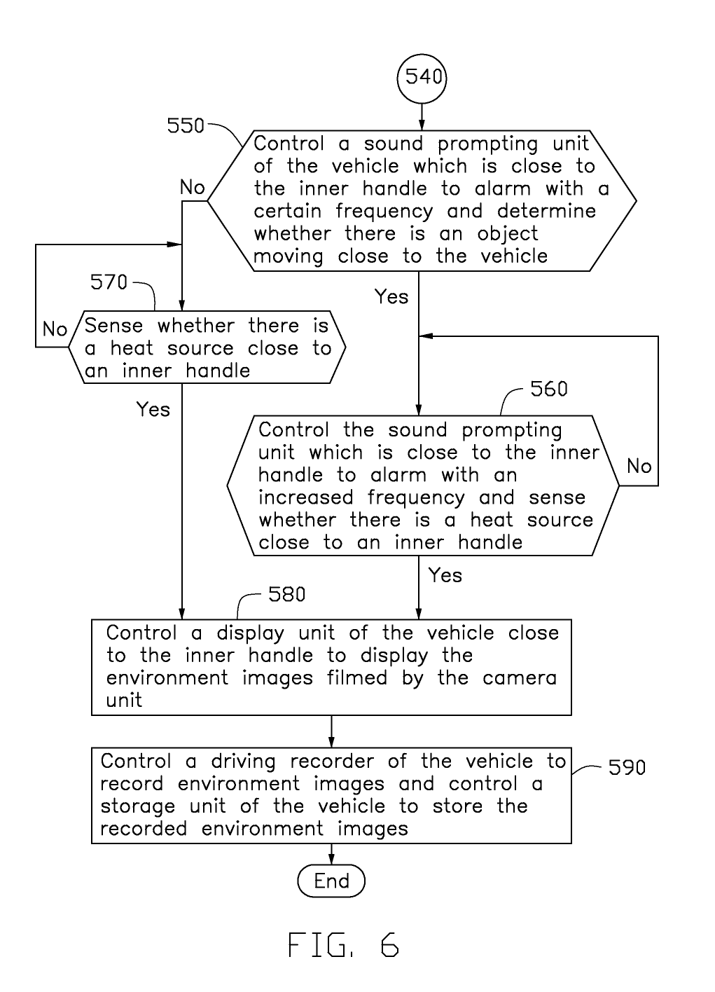

FIGS. 5 and 6 cooperatively illustrate a signal flowchart of a control method for collision avoidance while opening vehicle door. The control method is provided by way of example, as there are a variety of ways to carry out the method. The control method described below can be carried out using the configurations illustrated in FIG. 1, for example, and various elements of these figures are referenced in explaining the example method. Each block shown in FIGS. 5 and 6 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 510.

At block 510, a speed sensing unit of a vehicle senses a moving speed of the vehicle in real time.

At block 520, a light controlling module controls a light prompting unit of the vehicle to flicker with a certain frequency to prompt a driver and/or passengers on the vehicle when the sensed moving speed is zero, and an object detecting module controls a camera unit of the vehicle to film environment images beside the vehicle, and further determines whether a size of a certain feature of an object in continuous filmed environment images is becoming larger to determine whether there is an object moving close to the vehicle, if yes, the process goes to block 530, otherwise, the process continues the block 520.

At block 530, the object detecting module determines that there is an object moving close to the vehicle, and the light controlling module controls the light prompting unit to flicker with an increased frequency to prompt the driver and/or the passengers on the vehicle, and the less distance between the moving object and vehicle, and the larger frequency of the light prompting unit flickers.

At block 540, a heat sensing unit senses whether there is a heat source moving close to an inner handle, if yes, the process goes to block 550, otherwise, the process continues the block 540.

At block 550, a sound controlling module controls a sound prompting unit of the vehicle which is close to the inner handle to alarm with a certain frequency to prompt the driver and/or the passengers on the vehicle; the object detecting module controls the camera unit to film environment images beside the vehicle, and further determines whether a size of a certain feature of an object in continuous filmed environment images is becoming larger to sense whether there is an object moving close to the vehicle, if yes, the process goes to block 560, otherwise, the process continues the block 550.

At block 560, the sound controlling module further controls the sound prompting unit which is close to the inner handle to alarm with an increased frequency to prompt the driver and/or the passengers on the vehicle, and the less distance between the moving object and vehicle, and the larger frequency of the sound prompting unit alarms; and the heat sensing unit senses whether there is a heat source moving close to an inner handle, if yes, process goes to block 580, otherwise, the process continues the block 560.

At block 570, the heat sensing unit senses whether there is a heat source moving close to an inner handle, if yes, the process goes to block 580, otherwise, the process continues the block 570.

At block 580, a display controlling module controls a display unit of the vehicle close to the inner handle to display the environment images filmed by the camera unit. In this embodiment, the display controlling module controls a first display unit of the vehicle or a second display unit of the vehicle which is close to the inner handle to display the environment images filmed by the camera unit.

At block 590, a record controlling module controls a driving recorder of the vehicle to record environment images, and further controls a storage unit of the vehicle to store the recorded environment images.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A control system for collision avoidance while opening a vehicle door, running on a vehicle, the control system comprising:
a plurality of processing units; and
a plurality of modules coupled to the plurality of processing units, each of the plurality of modules including instructions to be executed by one or more of the plurality of processing units, the plurality of modules comprising:
a light controlling module configured to cause the plurality of processing units to control a light prompting unit of the vehicle to flicker with a certain frequency when a speed sensing unit of the vehicle senses that a moving speed of the vehicle is zero; and
a sound controlling module configured to cause the plurality of processing units to control a sound prompting unit of the vehicle which is close to an inner handle of the vehicle to alarm with a certain frequency when the moving speed of the vehicle is zero and a heat sensing unit of the vehicle senses that a heat source is moving close to the inner handle of the vehicle.

2. The control system of claim 1, wherein the plurality of modules further comprising:
an object detecting module configured to cause the plurality of processing units to control a camera unit of the vehicle to film environment images beside the vehicle, and determine that there is an object moving close to the vehicle when a size of a certain feature of an object in continuous filmed environment images is becoming larger;
wherein the light controlling module is further configured to control the light prompting unit to flicker with an increased frequency when there is an object moving close to the vehicle, and the less distance between the moving object and the vehicle, and the larger frequency of the light prompting unit flickers.

3. The control system of claim 1, wherein the plurality of modules further comprising:
an object detecting module configured to cause the plurality of processing units to control a camera unit of the vehicle to film environment images beside the vehicle, and determine that there is an object moving close to the vehicle when a size of a certain feature of an object in continuous filmed environment images is becoming larger;
wherein the sound controlling module is further configured to control the light prompting unit to flicker with an increased frequency when there is an object moving close to the vehicle, and the less distance between the moving object and the vehicle, and the larger frequency of the sound prompting unit alarms.

4. The control system of claim 1, wherein the plurality of modules further comprising:
a display controlling module configured to cause the plurality of processing units to control a display unit of the vehicle close to the inner handle to display environment images filmed by a camera unit of the vehicle.

5. The control system of claim 4, wherein the display unit comprises a first display unit mounted on front of a driver's seat and two second display units mounted on back of the driver's seat and a passenger's seat, the display controlling module is further configured to control one of the first display unit and two second display units which is close to the inner handle to display the environment images filmed by the camera unit.

6. The control system of claim 1, wherein the plurality of modules further comprising:
a record controlling module configured to cause the plurality of processing units to control a driving recorder of the vehicle to record environment images, and further controls a storage unit of the vehicle to store the recorded environment images.

7. A control method for collision avoidance while opening a vehicle door, running on a vehicle, the control method comprising:
sensing a moving speed of the vehicle;
controlling a light prompting unit of the vehicle to flicker with a certain frequency when the moving speed of the vehicle is zero;
sensing whether there is a heat source is moving close to an inner handle of the vehicle; and
controlling a sound prompting unit of the vehicle which is close to the inner handle of the vehicle to alarm with a certain frequency when the moving speed of the vehicle is zero and the heat source is moving close to the inner handle of the vehicle.

8. The control method of claim 7, wherein the control method further comprising:
controlling a camera unit of the vehicle to film environment images beside the vehicle;
determining whether a size of a certain feature of an object in continuous filmed environment images is becoming larger;
determining that the object is moving close to the vehicle when the size of the certain feature of the object in the continuous filmed environment images is becoming larger; and
controlling the light prompting unit to flicker with an increased frequency, and the less distance between the moving object and the vehicle, and the larger frequency of the light prompting unit sparkling.

9. The control method of claim 7, wherein the control method further comprising:
controlling a camera unit of the vehicle to film environment images beside the vehicle;
determining whether a size of a certain feature of an object in continuous filmed environment images is becoming larger;
determining that the object is moving close to the vehicle when the size of the certain feature of the object in the continuous filmed environment images is becoming larger; and
controlling the light prompting unit to flicker with an increased frequency, and the less distance between the moving object and vehicle, and t larger frequency of the sound prompting unit alarming.

10. The control method of claim 7, wherein the control method further comprising:
controlling a display unit of the vehicle close to the inner handle to display environment images filmed by a camera unit of the vehicle.

11. The control method of claim 8, wherein the display unit comprises a first display unit mounted on front of a driver's seat and two second display units mounted on back of the driver's seat and a passenger's seat, the control method further comprises:
controlling one of the first display unit and two second display units which is close to the inner handle to display the environment images filmed by the camera unit.

12. The control method of claim 7, wherein the control method further comprising:
controlling a driving recorder of the vehicle to record environment images; and
controlling a storage unit of the vehicle to store the recorded environment images.

13. A control method for collision avoidance while opening a vehicle door, running on a vehicle, the control method comprising:
sensing whether a vehicle is not moving;
determining whether a moving object is proximate to a side of the vehicle;
sensing interior movement of a door opener within the vehicle proximate to a vehicle door on the side of the vehicle;
issuing a first alarm in response to the vehicle not moving and the moving object is determined to be proximate to the side of the vehicle; and
issuing a second alarm in response the vehicle not moving, the moving object is determined to be proximate to the side of the vehicle, and interior movement of the door opener is sensed to be proximate to the vehicle door of the vehicle on the side of the vehicle.

14. The control method of claim 13, wherein the first and second alarms provide the same type of stimulus at different frequencies.

15. The control method of claim 13, wherein the sensing comprises sensing a heat source is moving close to an inner handle of the vehicle.
